(19) United States
(12) Patent Application Publication
(10) Pub. No.: US 2025/0159441 A1
(43) Pub. Date: May 15, 2025

(54) SENSING DATA TRANSMISSION METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Jianning LIU, Beijing (CN); Yang SHEN, Beijing (CN)

(21) Appl. No.: 18/835,635

(22) PCT Filed: Feb. 10, 2022
(86) PCT No.: PCT/CN2022/075910

§ 371 Date: Aug. 2, 2024

(51) Int. Cl. H04W 4/38; H04W 24/02; H04W 60/04; H04W 64/00

(52) U.S. Cl. CPC H04W 4/38; H04W 24/02; H04W 60/04; H04W 64/00

(57) ABSTRACT

A method for transmitting sensing data is performed by a first user equipment (UE), and the method includes: determining sensing data of a sensed object based on received sensing information; and sending the sensing data to a user plane function (UPF) of a core network through a base station, wherein the sensing data is sent by the UPF to a sensing function (SF) of the core network.

### CROSS REFERENCE TO RELATED APPLICATIONS

The present application is a U.S. national phase of International Application No. PCT/CN2022/075910, filed on Feb. 10, 2022, the disclosure of which is incorporated herein by reference in its entirety.

### TECHNICAL FIELD

The present disclosure relates to but is not limited to the field of wireless communication technologies, and in particular to methods and apparatuses for transmitting sensing data, a communication device, and a storage medium.

### BACKGROUND

The development of technologies such as communication network and artificial intelligence (AI) has promoted the intelligence of many industries. Emerging businesses such as smart transportation, smart cities, smart medical care, smart factories, and unmanned driving are deeply integrated with communication networks and have entered a new stage of development. In addition to communication requirements, the above businesses also have requirements of sensing service. For example, the unmanned driving service needs to sense environmental information around the vehicle in real time when the vehicle is driving, for example, distances of one or more vehicles ahead, weather conditions and traffic light signals, so that a vehicle driving policy can be adjusted in real time to ensure the safety of automatic driving. Currently, the implementation of sensing functions basically relies on specialized sensing equipment or devices, such as sensors, cameras, and radars. However, specialized equipment often has high costs and is inflexible in deployment, resulting in many limitations in usage scenarios and performance of the sensing service.

With the development and continuous evolution of mobile communication technology, base stations and terminals can be endowed with sensing capabilities to sense surrounding environments and objects.

### SUMMARY

Embodiments of the present disclosure provide methods and apparatuses for transmitting sensing data, a communication device, and a storage medium.

According to a first aspect of the embodiments of the present disclosure, there is provided a method for transmitting sensing data, which is performed by a first user equipment (UE) and includes: determining sensing data of a sensed object based on received sensing information; and sending the sensing data to a user plane function (UPF) of a core network through a base station, where the sensing data is sent by the UPF to a sensing function (SF) of the core network.

According to a second aspect of the embodiments of the present disclosure, there is provided a method for transmitting sensing data, which is performed by a user plane function (UPF) of a core network and includes: receiving sensing data of a sensed object sent by a first user equipment (UE) through a base station, where the sensing data is determined by the first UE based on received sensing information; and sending the sensing data to a sensing function (SF) of the core network.

According to a third aspect of the embodiments of the present disclosure, there is provided a communication device, including a processor, and a memory storing a program executable by the processor, where the processor is configured to perform the method according to the first aspect or the second aspect when running the executable program.

According to a fourth aspect of the embodiments of the present disclosure, there is provided a storage medium storing an executable program that, when executed by a processor, causes the processor to perform the method according to the first aspect or the second aspect.

It should be understood that the general description above and the detailed description below are only exemplary and explanatory, and cannot limit the embodiments of the present disclosure.

### BRIEF DESCRIPTION OF THE DRAWINGS

The accompanying drawings, which are incorporated into and constitute a part of the specification, illustrate embodiments in accordance with the present disclosure and together with the specification, serve to explain the principles of the embodiments of the present disclosure.

FIG. 1 is a structural diagram of a wireless communication system according to an embodiment.

FIG. 2 is a structural diagram of a radar system according to an embodiment.

FIG. 3 is a structural diagram of a communication and sensing system according to an embodiment.

FIG. 4 is a flowchart of a method for transmitting sensing data according to an embodiment.

FIG. 5 is a structural diagram of a communication system according to an embodiment.

FIG. 6 is a flowchart of another method for transmitting sensing data according to an embodiment.

FIG. 7 is a flowchart of yet another method for transmitting sensing data according to an embodiment.

FIG. 8 is a flowchart of yet another method for transmitting sensing data according to an embodiment.

FIG. 9 is a flowchart of yet another method for transmitting sensing data according to an embodiment.

FIG. 10 is a flowchart of yet another method for transmitting sensing data according to an embodiment.

FIG. 11 is a flowchart of yet another method for transmitting sensing data according to an embodiment.

FIG. 12 is a flowchart of yet another method for transmitting sensing data according to an embodiment.

FIG. 13 is a block diagram of an apparatus for transmitting sensing data according to an embodiment.

FIG. 14 is a block diagram of another apparatus for transmitting sensing data according to an embodiment.

FIG. 15 is a block diagram of an apparatus for transmitting sensing data according to an embodiment.

### DETAILED DESCRIPTION OF THE EMBODIMENTS

The exemplary embodiments will be described in detail herein, and examples thereof are shown in accompanying drawings. When the following descriptions refer to the accompanying drawings, unless otherwise indicated, the same numbers in different drawings represent the same or similar elements. The implementations described in the following exemplary embodiments do not represent all the implementations consistent with the embodiments of the present disclosure. Rather, they are merely examples of the apparatus and method consistent with some aspects of the present disclosure as detailed in the appended claims.

Terms used in the embodiments of the present disclosure are for the purpose of describing specific embodiments only, and are not intended to limit the embodiments of the present disclosure. The singular forms “a”, “an” and “this” used in the embodiments of the present disclosure and the appended claims are also intended to include plural forms, unless the context clearly indicates other meanings. It should also be understood that the term “and/or” as used herein refers to and includes any and all possible combinations of one or more of the associated listed items.

It should be understood that although terms first, second, third, etc. may be used in the embodiments of the present disclosure to describe various information, such information should not be limited to these terms. These terms are only used to distinguish the same type of information from each other. For example, first information may also be referred to as second information, and similarly, the second information may also be referred to as the first information without departing from the scope of the present disclosure. Depending on the context, the word “if” as used herein can be interpreted as “at the time of”, “when” or “in response to determining”.

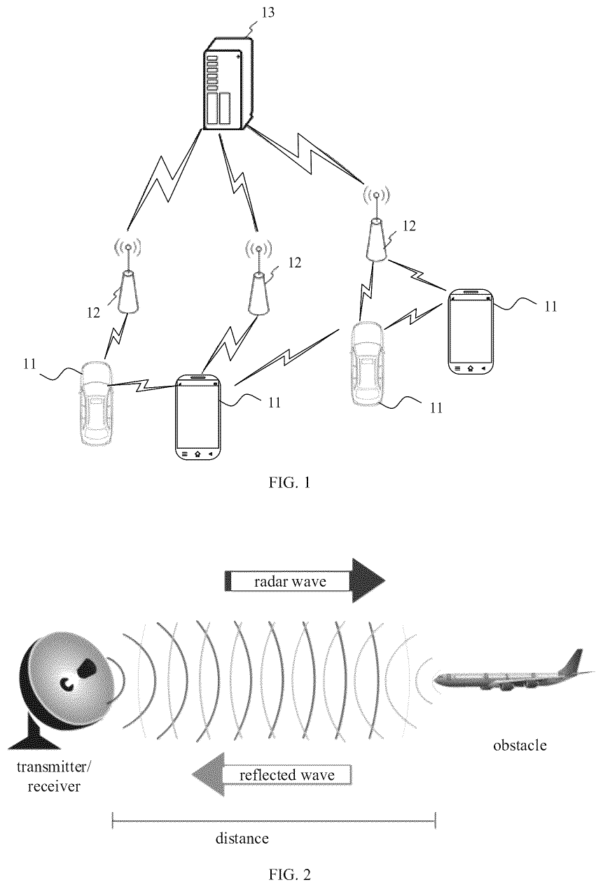

Referring to FIG. 1, FIG. 1 is a schematic structural diagram showing a wireless communication system provided in an embodiment of the present disclosure. As shown in FIG. 1, the wireless communication system is a communication system based on cellular mobile communication technology, and may include several terminals 11 and several base stations 12.

The terminal 11 may be a device that provides voice and/or data connectivity to a user. The terminal 11 may communicate with one or more core networks via a radio access network (RAN). The terminal 11 may be an Internet of Things terminal, such as a sensor device, a mobile phone (or a “cellular” phone) and a computer with an Internet of Things terminal. For example, the terminal 11 may be a fixed, portable, pocket-sized, handheld, built-in computer or vehicle-mounted apparatus, for example, a station (STA), a subscriber unit, a subscriber station, a mobile station, a mobile, a remote station, an access point, a remote terminal, an access terminal, a user terminal, a user agent, a user device, or user equipment (UE). Or, the terminal 11 may be a device of an unmanned aerial vehicle. Or, the terminal 11 may be a vehicle-mounted device, for example, a driving computer with a wireless communication function, or a wireless communication device externally connected with a driving computer. Or, the terminal 11 may be a roadside device, such as a street lamp, a signal lamp or other roadside devices with a wireless communication function.

The base station 12 may be a network side device in the wireless communication system. The wireless communication system may be a 4th generation mobile communication (4G) system, also referred to as a long term evolution (LTE) system. Or, the wireless communication system may be a 5G system, also referred to as a new radio (NR) system or a 5G NR system. Or, the wireless communication system may be a next generation system of the 5G system. The access network in the 5G system may be referred to as a new generation-radio access network (NG-RAN) or a machine type communication (MTC) system.

The base station 12 may be an evolved base station (eNB) used in the 4G system. Or, the base station 12 may be a centralized distributed architecture base station (gNB) used in the 5G system. When the base station 12 adopts the centralized distributed architecture, it usually includes a central unit (CU) and at least two distributed units (DUs). A protocol stack of a packet data convergence protocol (PDCP) layer, a radio link control (RLC) layer and a media access control (MAC) layer is provided in the central unit. A protocol stack of a physical (PHY) layer is provided in the distributed unit. The specific implementation of the base station 12 is not limited in the embodiments of the present disclosure.

A wireless connection may be established between the base station 12 and the terminal 11 through a wireless radio. In different embodiments, the wireless radio is a wireless radio based on the 4th generation mobile communication network technology (4G) standard. Or, the wireless radio is a wireless radio based on the 5th generation mobile communication network technology (5G) standard. For example, the wireless radio is a new radio. Or, the wireless radio may also be a wireless radio based on the next generation mobile communication network technology standard of the 5G.

In some embodiments, an end to end (E2E) connection may also be established between terminals 11, for example, a vehicle to vehicle (V2V) communication, a vehicle to infrastructure (V2I) communication and a vehicle to pedestrian (V2P) communication in a vehicle to everything (V2X) communication.

In some embodiments, the above wireless communication system may further include a network management device 13.

Several base stations 12 are connected to the network management device 13, respectively. The network management device 13 may be a core network device in the wireless communication system, for example, access and mobility management function (AMF), session management function (SMF), user plane function (UPF), policy control function (PCF), network repository function (NRF). The implementation form of the network management device 13 is not limited in the embodiments of the present disclosure.

Execution subjects involved in the embodiments of the present disclosure include but are not limited to: a UE such as a mobile phone terminal in a cellular mobile communication system, a network side device, for example, an access network device such as a base station, and a core network.

As shown in FIG. 2, radar is a detection system that uses radio waves to detect objects and determine distances, angles, or speeds of objects. Radar can be used to detect aircraft, ships, spacecraft, missiles, motor vehicles, meteorology, and/or terrain.

The radar system includes a transmitter, a receiver, and a processor. The transmitter is used to emit radar waves, which will be reflected or absorbed when encountering obstacles in the transmission process, and the reflected radar waves will be received by the receiver. The receiver and the processor are used to determine properties of an object. The use of radar technology to achieve sensing services requires specialized equipment, which is expensive and generally only used in specific industries and businesses. In addition, frequency bands used by radar lack unified management and authorization, which is easy to cause interference. Therefore, it is difficult to popularize traditional radar technology and realize flexible deployment.

The mobile communication network can adopt an integrated communication and sensing scheme to integrate the communication function and sensing function, so that the communication system has both communication function and sensing functions. By actively recognizing and analyzing characteristics of a wireless channel while transmitting sensing information, physical characteristics of the surrounding environment can be sensed.

As shown in FIG. 3, a communication and sensing system implementing the integrated communication and sensing scheme can include: a transmitter for sending sensing information; a receiver for sending sensing data to a processor upon receiving sensing information, where the sensing information received by the receiver can be reflected by a sensed object; and the processor for processing the sensing data received from the receiver and outputting a sensing result. Note that the processor here may include one or more processors, or one or more processing devices.

A communication device can act as one or more of the transmitter, the receiver, and the processor.

There is no solution on how to implement a communication and sensing service in a communication network. Therefore, how to implement the communication and sensing service in the communication network and meet needs of the communication and sensing in various scenarios is an urgent problem to be solved.

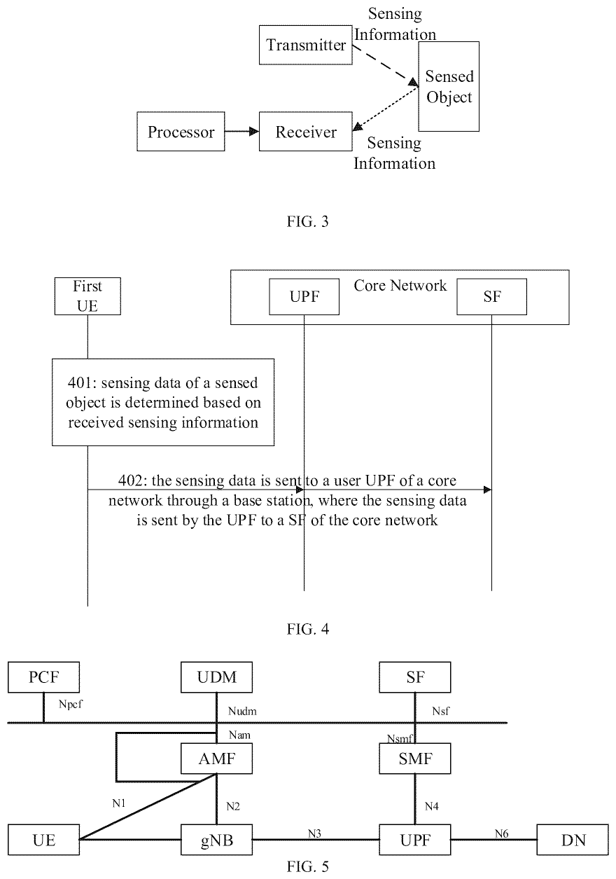

As shown in FIG. 4, this exemplary embodiment provides a method for transmitting sensing data. The method can be performed by a first user equipment (UE) of a cellular mobile communication system and includes steps 401 and 402.

In step 401, sensing data of a sensed object is determined based on received sensing information.

In step 402, the sensing data is sent to a user plane function (UPF) of a core network through a base station, where the sensing data is sent by the UPF to a sensing function (SF) of the core network.

The first UE may be a terminal such as a mobile phone in the cellular mobile communication system. The first UE may be a communication device used at least for receiving sensing information. The first UE may also transmit sensing information.

The sensing information can be signals used for both data communication and environmental sensing in the cellular mobile communication system. The sensing information can be interfered by the surrounding environment during transmission, such as reflection, which will produce different changes. The first UE senses the surrounding environment based on the received sensing information. The sensing information can be radio frequency signals, including millimeter wave signals, terahertz signals, etc.

The sensed object can include but is not limited to a moving object and a non-moving object.

In an embodiment, the sensing information is sent by the first UE; and/or, the sensing information is sent by a second UE, where the second UE is different from the first UE; and/or, the sensing information is sent by a base station.

As shown in FIG. 3, the first UE, the second UE, and/or the base station can all act as a transmitter of the sensing information. The first UE can act as a receiver of the sensing information and sense the sensing information.

For example, the sensing information is reflected by the sensed object during transmission. After receiving the reflected sensing information, the first UE records a receiving time, a receiving power, and/or a receiving direction of receiving the reflected sensing information. Then, the first UE transmits a sending time, a transmitting power, and/or a transmitting direction of the sensing information to determine a distance and/or an orientation of the sensed object. Further, the first UE can determine a geographical location of the sensed object based on its own geographical location and a relative positional relationship between the first UE and the sensed object.

The sensing data can include: raw sensing data obtained through processing such as digital-to-analog conversion and digital signal processing based on the received sensing information, a sensing result obtained by calculating the raw sensing data, etc.

For example, the raw sensing data can be digital information obtained by digital-to-analog conversion of the sensing information. The sensing result can be a size, a shape, a location, motion information and so on of the sensed object determined based on the raw sensing data.

In an embodiment, the raw sensing data may include feature data. The feature data can be used to determine sensed predetermined features. The predetermined features may include location features, motion features, and/or shape features, etc.

For example, the raw sensing data is sampled, and sampled raw sensing data is one type of the feature data. A result obtained by calculating the distance and/or direction of the feature data is the sensing result. For example, the feature data can be an arrival time of sampled reflected sensing information, the calculation of the feature data can be the calculation of a time of fly (TOF) of the sensing information, and the obtained sensing result is a distance from the sensed object to the first UE.

After determining the sensing data, the first UE can select sensing data to be sent to the UPF based on a predetermined reporting rule. The sent sensing data can be part or all of the sensing data determined by the first UE. The reporting rule can be specified by a communication protocol in advance or agreed between the first UE and the core network in advance.

As shown in FIG. 5, the first UE can first send the sensing data to the base station (for example, a gNB), which then sends the sensing data to the UPF, and the UPF further sends the sensing data to the SF for the SF to process the sensing data.

The SF can be an independent network element in the core network, and can also be implemented by other network elements in the core network such as a network exposure function (NEF).

In an embodiment, the UPF includes at least one of the following: a session anchor UPF; or an insert UPF.

The session anchor UPF may include the UPF when the first UE accesses the network and registers with the core network.

The insert UPF may include a UPF configured for the first UE by the core network after the first UE registers with the core network, which is different from the session anchor UPF. The core network may configure the UPF for the first UE based on a load status of the UPF and/or a service type of the UPF. For example, when the load of the session anchor UPF is greater than a load threshold, the core network can configure the insert UPF for the first UE to transmit the sensing data.

After receiving the sensing data reported by the first UE, the UPF can send the sensing data to the SF to process the sensing data.

In an embodiment, the SF includes at least one of the following functions: a network data analytics function (NWDAF); a location management function (LMF); or a network exposure function (NEF).

The SF can be an independent network element in the core network or can be implemented by other network elements in the core network.

The above NWDAF, LMF, and/or NEF are only examples, and the specific implementation is not limited to them.

In this way, the UE determines the sensing data based on the sensing information, sends the sensing data to the SF through the base station and UPF, thus realizing the transmission of the communication and sensing service from the UE to the core network in the cellular mobile communication network and meeting transmission requirements of the communication and sensing service.

In an embodiment, the sensing data of the sensed object is determined based on the received sensing information includes: determined raw sensing data of the sensed object is taken as the sensing data based on the received sensing information and one or more sensing parameters; and/or, a determined sensing result of the sensed object is taken as the sensing data based on the received sensing information and the one or more sensing parameters.

The raw sensing data may include digital data obtained by the first UE converting the sensing information from digital into analog, or feature data obtained by processing the digital data through digital signal processing or other manners, etc. The first UE can obtain the raw sensing data based on the configuration of the sensing parameters. In an embodiment, the raw sensing data may be intermediate data for determining the sensing result.

The sensing parameters can include filters for the sensing information, data filtering policies, etc., for the first UE to determine the sensing data.

For example, features of sensed objects sensed for different communication and sensing services are different. The features of sensed objects can include location features, motion features, and/or shape features. The location features can include a direction, a distance, etc. of the sensed object relative to the first UE. The motion features can include a motion speed and/or a motion angle of the sensed object relative to the first UE. The shape features can include a size and/or a shape of the sensed object.

For different sensing services, the first UE can adopt different sensing parameters, and determine sensing parameters of predetermined features of the sensed object based on the received sensing information. The sensing parameters can be set based on the predetermined features.

For example, for the location features, the sensing parameters can filter sensing data associated with location features, such as a receiving time, a receiving power, and/or a receiving direction of the sensing information, as the sensing data. For the motion features of the sensed object, the sensing parameters can filter Doppler shift data of the sensing information as the sensing data to determine the motion speed of the sensed object.

The raw sensing data can be processed by the first UE to obtain the sensing result. The raw sensing data can also be sent by the first UE to the SF, and the SF determines the sensing result. The first UE can also send both the raw sensing data and the sensing result to the SF.

For example, since SF has a strong data processing capability, the first UE can send the raw sensing data to the SF for processing after obtaining the raw sensing data, reducing the data processing load of the first UE. The sensing result determined by the SF based on the raw sensing data can be sent to the first UE through the UPF via the base station.

In an embodiment, the sensing parameters include at least one of the following: a type parameter of the sensed object; a collection configuration of the sensing data; a reporting configuration of the sensing data; a region configuration of the sensing information; or a type parameter of the sensing information.

The type parameter of the sensed object can be used to filter sensing data of different types of sensed objects, for example, sensing data of a sensed object in a moving state, or sensing data of a sensed object in a static state.

The collection configuration of the sensing data can be a configuration of collecting the sensing information for determining the sensing data. The collection configuration may include a configuration of collecting the sensing information, a method for determining the sensing data, etc.

In an embodiment, the collection configuration of the sensing data includes at least one of the following: a collection time configuration of the sensing data; or a collection frequency configuration of the sensing data.

The collection time configuration can be a time configuration for collecting the sensing information and determining the sensing data, including a collection time, a collection period, etc. The collection time can include but is not limited to a starting time, an ending time, and/or a duration of the collection.

The collection frequency configuration can be a frequency configuration for collecting the sensing information and determining the sensing data, which can include: a frequency of collecting the sensing information, etc.

The reporting configuration of the sensing data is used to configure a configuration for reporting the sensing data to the UPF, that is, a configuration for reporting the sensing data is selected from the sensing data.

In an embodiment, the reporting configuration of the sensing data includes at least one of the following: a reporting period of the sensing data; a reporting path of the sensing data; a type of the sensing data reported; or a subscription event of reporting of the sensing data.

The reporting period can be a period for reporting the sensing data, which can include but is not limited to a time interval, a starting time, an ending time, and/or a duration of reporting the sensing data. The reporting period can also include a single reporting, etc.

The reporting path may include a path for forwarding the sensing data, etc. For example, the reporting path may include: the first UE reports the sensing data to the UPF through the base station, and the UPF sends the sensing data to the SF, etc.

The type of the sensing data reported may include the type of the sensing data included in the sensing data. The type of the sensing data can include raw sensing data and/or the sensing result.

The subscription event may include a triggering event that triggers the first UE to report the sensing data. The core network can send a list of subscription events to the first UE, and the first UE reports the sensing data when requirements of a subscription event are satisfied. The subscription event may include but is not limited to: a signaling path status of an application function (AF) session, a access type and a radio access technology (RAT) type, a public land mobile network (PLMN) identifier, access network information (i.e., a user location and/or user time zone information), a usage report, a resource allocation result, failure to achieve a quality of service (QoS) goal, etc.

The region configuration of the sensing information can be used to indicate a region where the first UE needs to determine sensing data.

The type parameter of the sensing information can be used to indicate a type of sensing information that the first UE needs to sense, for example, a frequency band of the sensing information that the first UE needs to sense.

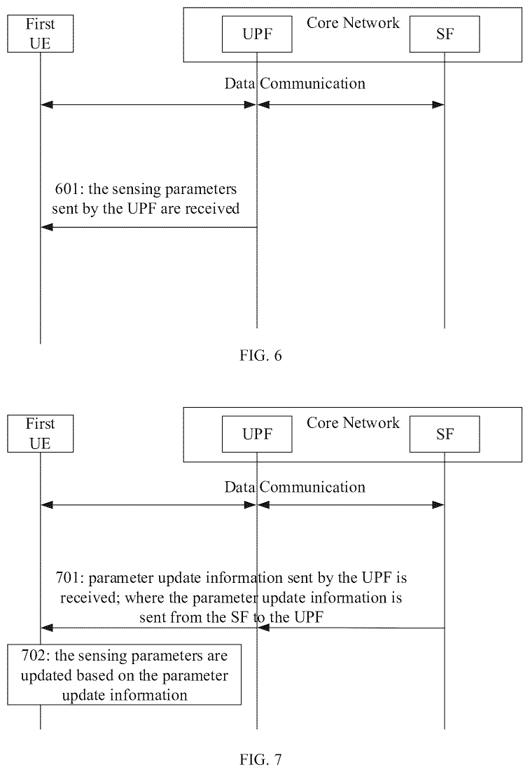

In an embodiment, as shown in FIG. 6, the method further includes step 601.

In step 601, the sensing parameters sent by the UPF are received.

Step 601 can be implemented separately or in combination with step 401 and/or step 402.

Here, the sensing parameters can be sent by the core network to the first UE. The sensing parameters can be sent to the first UE by the UPF of the core network.

For example, the sensing parameters can be sent by the core network to the first UE when the first UE registers with the network, or can be dynamically sent by the core network to the first UE after the sensing service is triggered.

In an embodiment, the core network can combine an operator policy and contract data of the first UE to generate the sensing parameters.

In another embodiment, the sensing parameters may be generated by at least one of the following functions of the core network: a sensing function (SF), a policy control function (PCF), an access and mobility management function (AMF), a session management function (SMF), an application function (AF), and a network data analytics function (NWDAF).

In an embodiment, as shown in FIG. 7, the method further includes steps 701 and 702.

In step 701, parameter update information sent by the UPF is received; where the parameter update information is sent from the SF to the UPF.

In step 702, the sensing parameters are updated based on the parameter update information.

Steps 701 and 702 can be implemented separately or in combination with step 401 and/or step 402 and/or step 601.

A network element in the core network, such as the SF, can determine whether the sensing parameters need to be updated. The SF can interact with the PCF and a unified data management (UDM) to obtain the parameter update information.

For example, the SF can determine whether the sensing parameters need to be updated based on the sensing data sent by the first UE. The SF can determine whether the sensing parameters need to be updated based on whether the sensing data satisfies sensing requirements and/or QoS requirements.

The SF can send the parameter update information to the first UE through the UPF.

For example, after receiving the sensing data sent by the first UE, the SF can send a response message to the first UE, where the response message can carry the parameter update information.

The first UE can update the sensing parameters based on the received parameter update information for subsequent determination of sensing data.

In an embodiment, the sensing data of the sensed object is determined based on the received sensing information, which includes at least one of the following: based on trigger information, the sensing data of the sensed object is determined based on the received sensing information; where the triggering information is sent by one of the following: an upper layer sensing application function of the first UE; an upper layer sensing application function of a second UE that sends the sensing information; a sensing function of one or more base stations of the first UE; a sensing function of the core network; a sensing function of a control plane; a sensing function on the UPF; an application function of a network to which the first UE belongs; or application functions outside the network to which the first UE belongs.

The first UE determines the sensing service of the sensing data based on the sensing information, which may be triggered by the trigger information. The upper layer sensing application function can include an upper layer application, etc.

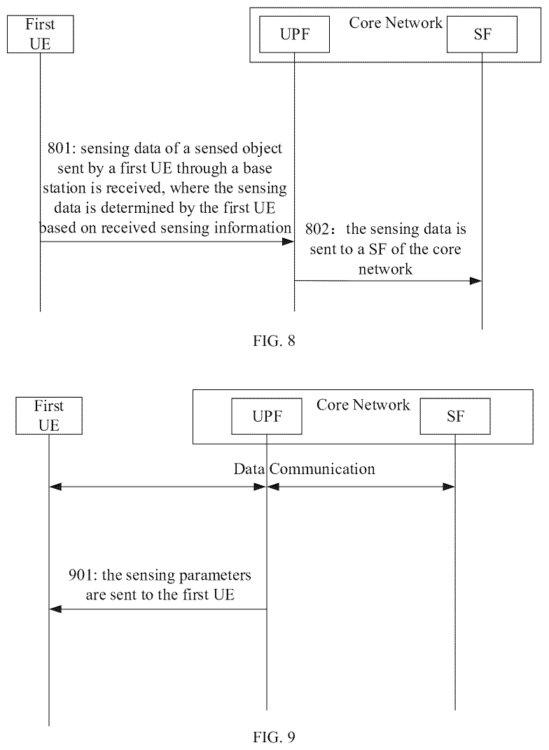

As shown in FIG. 8, this exemplary embodiment provides a method for transmitting sensing data. The method can be performed by a user plane function (UPF) of a core network of a cellular mobile communication system and includes steps 801 and 802.

In step 801, sensing data of a sensed object sent by a first user equipment (UE) through a base station is received, where the sensing data is determined by the first UE based on received sensing information.

In step 802, the sensing data is sent to a sensing function (SF) of the core network.

The first UE may be a terminal such as a mobile phone in the cellular mobile communication system. The first UE may be a communication device used at least for receiving sensing information. The first UE may also transmit sensing information.

The sensing information can be signals used for both data communication and environmental sensing in the cellular mobile communication system. The sensing information can be interfered by the surrounding environment during transmission, such as reflection, which will produce different changes. The first UE senses the surrounding environment based on the received sensing information. The sensing information can be radio frequency signals, including millimeter wave signals, terahertz signals, etc.

In an embodiment, the sensing information is sent by the first UE; and/or, the sensing information is sent by a second UE, where the second UE is different from the first UE; and/or, the sensing information is sent by a base station.

As shown in FIG. 3, the first UE, the second UE, and/or the base station can all act as a transmitter of the sensing information. The first UE can act as a receiver of the sensing information and sense the sensing information.

For example, the sensing information is reflected by the sensed object during transmission. After receiving the reflected sensing information, the first UE records a receiving time, a receiving power, and/or a receiving direction of receiving the reflected sensing information. Then, the first UE transmits a sending time, a transmitting power, and/or a transmitting direction of the sensing information to determine a distance and/or an orientation of the sensed object. Further, the first UE can determine a geographical location of the sensed object based on its own geographical location and a relative positional relationship between the first UE and the sensed object.

The sensing data can include: raw sensing data obtained through processing such as digital-to-analog conversion and digital signal processing based on the received sensing information, a sensing result obtained by calculating the raw sensing data, etc.

For example, the raw sensing data can be digital information obtained by digital-to-analog conversion of the sensing information. The sensing result can be a size, a shape, a location, motion information and so on of the sensed object determined based on the raw sensing data.

In an embodiment, the raw sensing data may include feature data. The feature data can be used to determine sensed predetermined features. The predetermined features may include location features, motion features, and/or shape features, etc.

For example, the raw sensing data is sampled, and sampled raw sensing data is one type of the feature data. A result obtained by calculating the distance and/or direction of the feature data is the sensing result. For example, the feature data can be an arrival time of sampled reflected sensing information, the calculation of the feature data can be the calculation of a time of fly (TOF) of the sensing information, and the obtained sensing result is a distance from the sensed object to the first UE.

After determining the sensing data, the first UE can select sensing data to be sent to the UPF based on a predetermined reporting rule. The sent sensing data can be part or all of the sensing data determined by the first UE. The reporting rule can be specified by a communication protocol in advance or agreed between the first UE and the core network in advance.

In the schematic architectural diagram of a communication system shown in FIG. 5, the first UE can first send the sensing data to the base station (for example, a gNB), which then sends the sensing data to the UPF, and the UPF further sends the sensing data to the SF for the SF to process the sensing data.

The SF can be an independent network element in the core network, and can also be implemented by other network elements in the core network such as a network exposure function (NEF).

In an embodiment, the UPF includes at least one of the following: a session anchor UPF; or an insert UPF.

The session anchor UPF may include the UPF when the first UE accesses the network and registers with the core network.

The insert UPF may include a UPF configured for the first UE by the core network after the first UE registers with the core network, which is different from the session anchor UPF. The core network may configure the UPF for the first UE based on a load status of the UPF and/or a service type of the UPF. For example, when the load of the session anchor UPF is greater than a load threshold, the core network can configure the insert UPF for the first UE to transmit the sensing data.

After receiving the sensing data reported by the first UE, the UPF can send the sensing data to the SF to process the sensing data.

In an embodiment, the SF includes at least one of the following functions: a network data analytics function (NWDAF); a location management function (LMF); or a network exposure function (NEF).

The SF can be an independent network element in the core network or can be implemented by other network elements in the core network.

The above NWDAF, LMF, and/or NEF are only examples, and the specific implementation is not limited to them.

In this way, the UE determines the sensing data based on the sensing information, sends the sensing data to the SF through the base station and UPF, thus realizing the transmission of the communication and sensing service from the UE to the core network in the cellular mobile communication network and meeting transmission requirements of the communication and sensing service.

In an embodiment, the sensing data includes: raw sensing data of the sensed object determined by the first UE based on the received sensing information and one or more sensing parameters; and/or, a sensing result of the sensed object determined by the first UE based on the received sensing information and the one or more sensing parameters.

The raw sensing data may include digital data obtained by the first UE converting the sensing information from digital into analog, or feature data obtained by processing the digital data through digital signal processing or other manners, etc. The first UE can obtain the raw sensing data based on the configuration of the sensing parameters. In an embodiment, the raw sensing data may be intermediate data for determining the sensing result.

The sensing parameters can include filters for the sensing information, data filtering policies, etc., for the first UE to determine the sensing data.

For example, features of sensed objects sensed for different communication and sensing services are different. The features of sensed objects can include location features, motion features, and/or shape features. The location features can include a direction, a distance, etc. of the sensed object relative to the first UE. The motion features can include a motion speed and/or a motion angle of the sensed object relative to the first UE. The shape features can include a size and/or a shape of the sensed object.

For different sensing services, the first UE can adopt different sensing parameters, and determine sensing parameters of predetermined features of the sensed object based on the received sensing information. The sensing parameters can be set based on the predetermined features.

For example, for the location features, the sensing parameters can filter sensing data associated with location features, such as a receiving time, a receiving power, and/or a receiving direction of the sensing information, as the sensing data. For the motion features of the sensed object, the sensing parameters can filter Doppler shift data of the sensing information as the sensing data to determine the motion speed of the sensed object.

The raw sensing data can be processed by the first UE to obtain the sensing result. The raw sensing data can also be sent by the first UE to the SF, and the SF determines the sensing result. The first UE can also send both the raw sensing data and the sensing result to the SF.

For example, since SF has a strong data processing capability, the first UE can send the raw sensing data to the SF for processing after obtaining the raw sensing data, reducing the data processing load of the first UE. The sensing result determined by the SF based on the raw sensing data can be sent to the first UE through the UPF via the base station.

In an embodiment, the sensing parameters include at least one of the following: a type parameter of the sensed object; a collection configuration of the sensing data; a reporting configuration of the sensing data; a region configuration of the sensing information; or a type parameter of the sensing information.

The type parameter of the sensed object can be used to filter sensing data of different types of sensed objects, for example, sensing data of a sensed object in a moving state, or sensing data of a sensed object in a static state.

The collection configuration of the sensing data can be a configuration of collecting the sensing information for determining the sensing data. The collection configuration may include a configuration of collecting the sensing information, a method for determining the sensing data, etc.

In an embodiment, the collection configuration of the sensing data includes at least one of the following: a collection time configuration of the sensing data; or a collection frequency configuration of the sensing data.

The collection time configuration can be a time configuration for collecting the sensing information and determining the sensing data, including a collection time, a collection period, etc. The collection time can include but is not limited to a starting time, an ending time, and/or a duration of the collection.

The collection frequency configuration can be a frequency configuration for collecting the sensing information and determining the sensing data, which can include: a frequency of collecting the sensing information, etc.

The reporting configuration of the sensing data is used to configure a configuration for reporting the sensing data to the UPF, that is, a configuration for reporting the sensing data is selected from the sensing data.

In an embodiment, the reporting configuration of the sensing data includes at least one of the following: a reporting period of the sensing data; a reporting path of the sensing data; a type of the sensing data reported; or a subscription event of reporting of the sensing data.

The reporting period can be a period for reporting the sensing data, which can include but is not limited to a time interval, a starting time, an ending time, and/or a duration of reporting the sensing data. The reporting period can also include a single reporting, etc.

The reporting path may include a path for forwarding the sensing data, etc. For example, the reporting path may include: the first UE reports the sensing data to the UPF through the base station, and the UPF sends the sensing data to the SF, etc.

The type of the sensing data reported may include the type of the sensing data included in the sensing data. The type of the sensing data can include raw sensing data and/or the sensing result.

The subscription event may include a triggering event that triggers the first UE to report the sensing data. The core network can send a list of subscription events to the first UE, and the first UE reports the sensing data when requirements of a subscription event are satisfied. The subscription event may include but is not limited to: a signaling path status of an application function (AF) session, a access type and a radio access technology (RAT) type, a public land mobile network (PLMN) identifier, access network information (i.e., a user location and/or user time zone information), a usage report, a resource allocation result, failure to achieve a quality of service (QoS) goal, etc.

The region configuration of the sensing information can be used to indicate a region where the first UE needs to determine sensing data.

The type parameter of the sensing information can be used to indicate a type of sensing information that the first UE needs to sense, for example, a frequency band of the sensing information that the first UE needs to sense.

In an embodiment, as shown in FIG. 9, the method further includes step 901.

In step 901, the sensing parameters are sent to the first UE.

Step 901 can be implemented separately or in combination with step 801 and/or step 802.

Here, the sensing parameters can be sent by the core network to the first UE. The sensing parameters can be sent to the first UE by the UPF of the core network.

For example, the sensing parameters can be sent by the core network to the first UE when the first UE registers with the network, or can be dynamically sent by the core network to the first UE after the sensing service is triggered.

In an embodiment, the core network can combine an operator policy and contract data of the first UE to generate the sensing parameters.

In another embodiment, the sensing parameters may be generated by at least one of the following functions of the core network: a sensing function (SF), a policy control function (PCF), an access and mobility management function (AMF), a session management function (SMF), an application function (AF), and a network data analytics function (NWDAF).

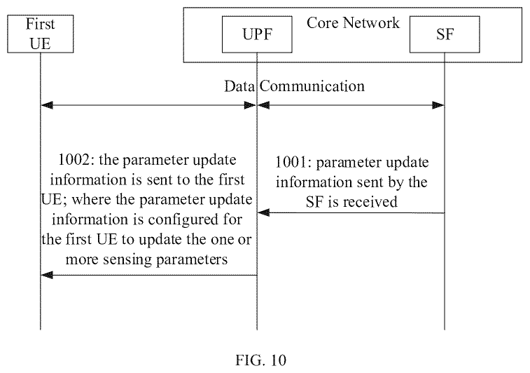

In an embodiment, as shown in FIG. 10, the method further includes steps 1001 and 1002.

In step 1001, parameter update information sent by the SF is received.

In step 1002, the parameter update information is sent to the first UE: where the parameter update information is configured for the first UE to update the one or more sensing parameters.

Steps 1001 and 1002 can be implemented separately or in combination with step 801 and/or step 802 and/or step 901.

A network element in the core network, such as the SF, can determine whether the sensing parameters need to be updated. The SF can interact with the PCF and a unified data management (UDM) to obtain the parameter update information.

For example, the SF can determine whether the sensing parameters need to be updated based on the sensing data sent by the first UE. The SF can determine whether the sensing parameters need to be updated based on whether the sensing data satisfies sensing requirements and/or QoS requirements.

The SF can send the parameter update information to the first UE through the UPF.

For example, after receiving the sensing data sent by the first UE, the SF can send a response message to the first UE, where the response message can carry the parameter update information.

The first UE can update the sensing parameters based on the received parameter update information for subsequent determination of sensing data.

The following provides a specific example in combination with any of the above embodiments.

For the support of a communication and sensing function for a terminal UE, and an architecture that an enhancing core network (CN) user plane supports transmission of communication and sensing data, signaling processing and transmission of sensing data in a control plane between the terminal UE and a network layer are involved.

According to different sensing data uploaded by the UE, it can be divided into: 1) raw sensing data; 2) secondary data processed locally by the UE, for example, whether the sensing data has changed or not, the sensing feature results, etc.

According to different functions involved in receiving and sending objects, it can be divided into: 1) UE sends and receives itself; 2) gNB sends and UE receives; 3) UE1 sends and UE2 receives.

According to different triggering objects of the communication and sensing service, it can be divided into: 1) a UE application triggering; 2) a network function (NF) triggering on a network side; 3) an application function (AF) triggering on the network side;

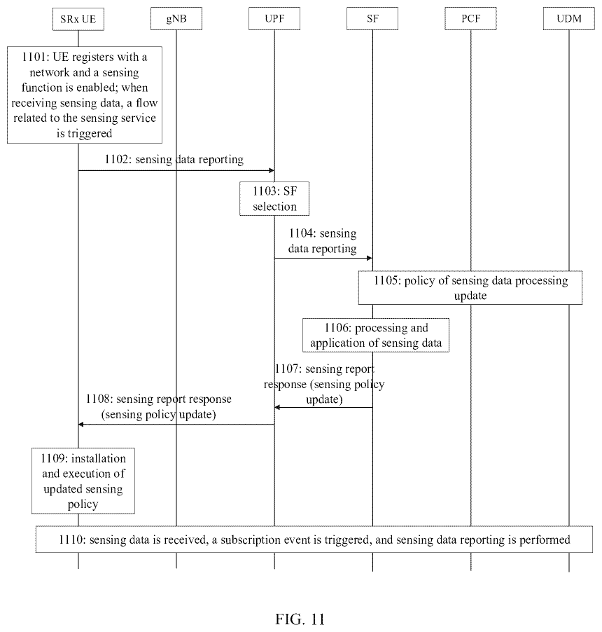

As shown in FIG. 11, a reporting process for sensing data processing may include steps 1101 to 1110.

Step 1101: a receiver of a sensing service, a UE, has registered with a network and a sensing function has been enabled. Optionally, the UE receiving sensing information receives a sensing policy (i.e., sensing parameters) sent by the network, installs and executes the sensing policy. When receiving sensing data, a data reporting and processing flow of the sensing service is triggered.

A sender of the sensing information can be the UE itself that receives the sensing information, or a gNB in the network, or other UEs in the network.

The trigger of the sensing service is one of the following functions: an upper layer sensing application function of the UE receiving the sensing information, an upper layer sensing application function of the UE sending the sensing information, a sensing function on the gNB in the network, a sensing function (SF) in the network, a sensing function on relevant functions of a network control plane, an AF in the network, and an AF of a third-party connected by the network.

The sensing policy includes at least one of the following: a type of the sensing service, a type of a sensed object, a collection method of the sensing data, a collection frequency policy of the sensing data, sensing time or period, a single or periodic reporting mode of the sensing data, a reporting path of the sensing data, a reporting subscription event of the sensing data, a reporting format of the sensing data being raw sensing data or processed data, a sensing region policy, a type of the sensing information.

The sensing policy is generated by one of the following functions: the SF, a policy control function (PCF), an access and mobility management function (AMF), a session management function (SMF), the AF, a network data analytics function (NWDAF). The function of generating the sensing policy, combined with an operator policy and contract data, generates the sensing policy. The sensing policy is pre-configured to the UE when the UE registers with the network, or dynamically sent to the UE after the sensing service is triggered.

Step 1102: SRx UE (the UE receiving the sensing information) receives the sensing information, decides and sends sensing data to a gNB based on the local sensing policy. The reported sensing data is forwarded to a network user plane function (UPF, which can be a session anchor UPF or an insert UPF) through the gNB. The sensing data is feature information (feature data) related to the sensed object. The UE determines feature information (feature data) of the sensed object to be sent to the network based on the sensing policy and the received sensing information.

Step 1103: the UPF receives the sensing data and needs to forward the sensing data to the corresponding SF of the sensing service. If the UPF does not have specific SF information, an appropriate SF can be discovered and selected through a network repository function (NRF).

Step 1104: the UPF reports the sensing data to the selected SF. Optionally, the UPF can forward the sensing data to the selected SF through the NEF according to network deployment or sensing service characteristics. The SF can be an independent function or an enhanced function on one of the following network functions: the NWDAF, a location management function (LMF), the NEF.

Step 1105: the SF receives the reported sensing data. Optionally, the SF determines whether a processing policy for the sensing data needs to be updated, and interacts with the PCF and a unified data management (UDM) to obtain a corresponding data processing policy.

Step 1106: the SF executes data processing, storage, and application of the sensing service according to data processing policies such as an operator policy and a contract.

Step 1107: the SF returns a sensing report response message to the UPF. Optionally, the response message carries an updated sensing policy.

Step 1108: after forwarding by the eNB, the UPF returns the sensing report response message to the SRx UE. Optionally, the response message carries the updated sensing policy.

Step 1109: the SRx UE receives a new sensing policy and installs it for execution. If there is no new sensing application, the SRx UE can suspend sensor functions related to the sensing service, and reception and processing functions of sensing information for the sensing service.

Step 1110: if the SRx UE detects sensing data and sensing reporting conditions are satisfied (a subscription event is triggered, or a reporting request is received), sensing data reporting is performed. For details, see steps 1102 to 1108.

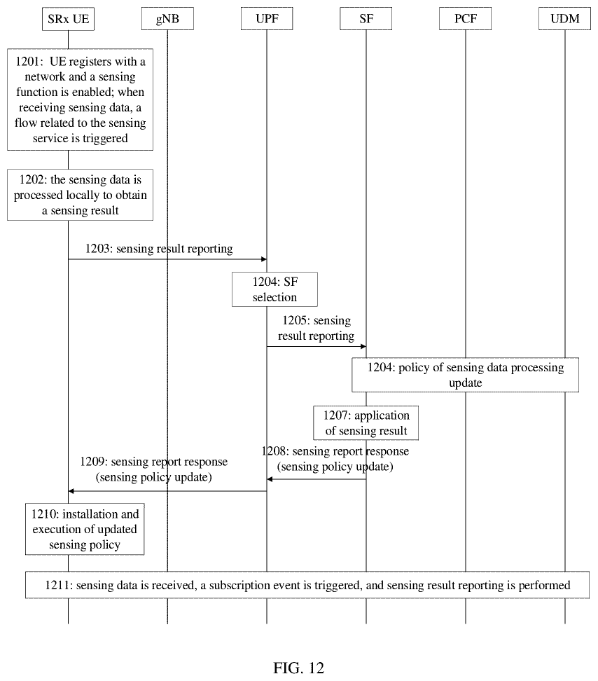

As shown in FIG. 12, another reporting process for sensing data processing may include steps 1201 to 1211.

Step 1201: a receiver of a sensing service, a UE, has registered with a network and a sensing function has been enabled. Optionally, the UE receiving sensing information receives a sensing policy (i.e., sensing parameters) sent by the network, installs and executes the sensing policy. When receiving sensing data, a data reporting and processing flow of the sensing service is triggered.

A sender of the sensing information can be the UE itself that receives the sensing information, or a gNB in the network, or other UEs in the network.

The trigger of the sensing service is one of the following functions: an upper layer sensing application function of the UE receiving the sensing information, an upper layer sensing application function of the UE sending the sensing information, a sensing function on the gNB in the network, a sensing function (SF) in the network, a sensing function on relevant functions of a network control plane, an AF in the network, and an AF of a third-party connected by the network.

The sensing policy includes at least one of the following: a type of the sensing service, a type of a sensed object, a collection method of the sensing data, a collection frequency policy of the sensing data, sensing time or period, a single or periodic reporting mode of the sensing data, a reporting path of the sensing data, a reporting subscription event of the sensing data, a reporting format of the sensing data being raw sensing data or processed data, a sensing region policy, a type of the sensing information.

The sensing policy is generated by one of the following functions: the SF, a policy control function (PCF), an access and mobility management function (AMF), a session management function (SMF), the AF, a network data analytics function (NWDAF). The function of generating the sensing policy, combined with an operator policy and contract data, generates the sensing policy. The sensing policy is pre-configured to the UE when the UE registers with the network, or dynamically sent to the UE after the sensing service is triggered.

Step 1202: SRx UE (the UE receiving the sensing information) receives the sensing information and determines sensing data based on the local sensing policy. The sensing data is processed locally to obtain a sensing result.

Step 1203: the sensing result is forwarded to a network user plane function (UPF, which can be a session anchor UPF or an insert UPF) through the gNB.

Step 1204: the UPF receives the sensing result and needs to forward the sensing result to the corresponding SF of the sensing service. If the UPF does not have specific SF information, an appropriate SF can be discovered and selected through a network repository function (NRF).

Step 1205: the UPF reports the sensing result to the selected SF. Optionally, the UPF can forward the sensing result to the selected SF through the NEF according to network deployment or sensing service characteristics. The SF can be an independent function or an enhanced function on one of the following network functions: the NWDAF, a location management function (LMF), the NEF.

Step 1206: the SF receives the reported sensing result. Optionally, the SF determines whether a processing policy for the sensing data needs to be updated, and interacts with the PCF and a unified data management (UDM) to obtain a corresponding data processing policy.

Step 1207: the SF can directly execute the application if a data processing result of the sensing service is reported; if classified or extracted data after the processing is reported, the SF will perform secondary processing of the sensing data according to a network sensing policy and then executing the application.

Step 1208: the SF returns a sensing report response message to the UPF. Optionally, the response message carries an updated sensing policy.

Step 1209: after forwarding by the eNB, the UPF returns the sensing report response message to the SRx UE. Optionally, the response message carries the updated sensing policy.

Step 1210: the SRx UE receives a new sensing policy and installs it for execution. If there is no new sensing application, the SRx UE can suspend sensor functions related to the sensing service, and reception and processing functions of sensing information for the sensing service.

Step 1211: if the SRx UE detects sensing data and sensing reporting conditions are satisfied (a subscription event is triggered, or a reporting request is received), sensing result reporting is performed. For details, see steps 1202 to 1209.

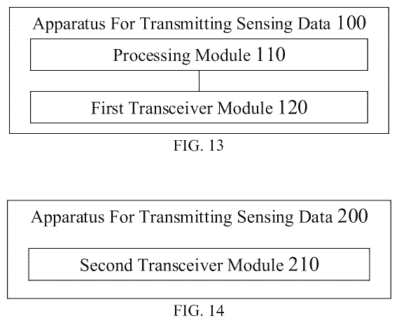

An embodiment of the present disclosure also provides an apparatus for transmitting sensing data. As shown in FIG. 13, the apparatus is applied to a first UE of cellular mobile wireless communication. The apparatus 100 includes: a processing module 110, configured to determine sensing data of a sensed object based on received sensing information; and a first transceiver module 120, configured to send the sensing data to a user plane function (UPF) of a core network through a base station, where the sensing data is sent by the UPF to a sensing function (SF) of the core network.

In an embodiment, the processing module 110 is specifically configured to: take determined raw sensing data of the sensed object as the sensing data based on the received sensing information and one or more sensing parameters; and/or, take a determined sensing result of the sensed object as the sensing data based on the received sensing information and the one or more sensing parameters.

In an embodiment, the one or more sensing parameters include at least one of: a type parameter of the sensed object; a collection configuration of the sensing data; a reporting configuration of the sensing data; a region configuration of the sensing information; or a type parameter of the sensing information.

In an embodiment, the collection configuration of the sensing data includes at least one of: a collection time configuration of the sensing data; or a collection frequency configuration of the sensing data.

In an embodiment, the reporting configuration of the sensing data includes at least one of: a reporting period of the sensing data; a reporting path of the sensing data; a type of the sensing data reported; or a subscription event of reporting of the sensing data.

In an embodiment, the first transceiver module 120 is further configured to: receive parameter update information sent by the UPF; where the parameter update information is sent from the SF to the UPF; where the processing module 110 is further configured to: update the one or more sensing parameters based on the parameter update information.

In an embodiment, the sensing information is sent by the first UE; and/or, the sensing information is sent by a second UE, where the second UE is different from the first UE; and/or, the sensing information is sent by a base station.

In an embodiment, the UPF includes at least one of: a session anchor UPF; or an insert UPF.

In an embodiment, the SF includes at least one of: a network data analytics function (NWDAF); a location management function (LMF); or a network exposure function (NEF).

In an embodiment, determining the sensing data of the sensed object based on the received sensing information includes at least one of: based on trigger information, determining the sensing data of the sensed object according to the received sensing information; where the triggering information is sent by one of: an upper layer sensing application function of the first UE; an upper layer sensing application function of a second UE that sends the sensing information; a sensing function of one or more base stations of the first UE; a sensing function of the core network; a sensing function of a control plane; a sensing function on the UPF; an application function of a network to which the first UE belongs; or application functions outside the network to which the first UE belongs.

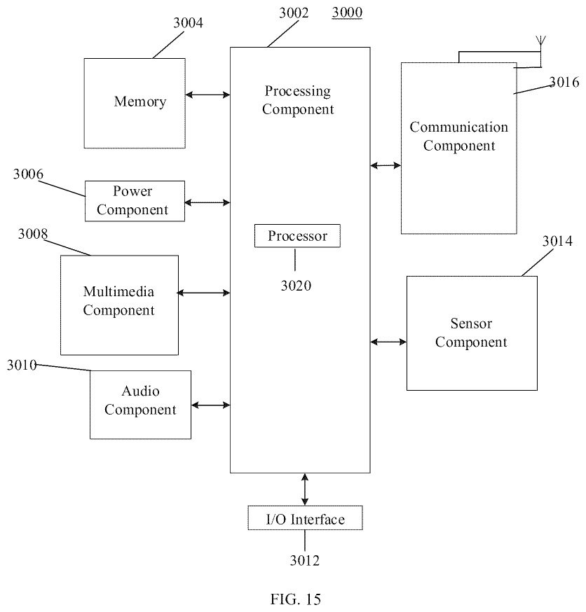

An embodiment of the present disclosure also provides an apparatus for transmitting sensing data. As shown in FIG. 14, the apparatus is applied to a user plane function (UPF) of a core network of cellular mobile wireless communication. The apparatus 200 includes: a second transceiver module 210, configured to receive sensing data of a sensed object sent by a first user equipment (UE) through a base station, where the sensing data is determined by the first UE based on received sensing information.

The second transceiver module 210 is further configured to send the sensing data to a sensing function (SF) of the core network.

In an embodiment, the sensing data includes: raw sensing data of the sensed object determined by the first UE based on the received sensing information and one or more sensing parameters; and/or, a sensing result of the sensed object determined by the first UE based on the received sensing information and the one or more sensing parameters.

In an embodiment, the one or more sensing parameters include at least one of: a type parameter of the sensed object; a collection configuration of the sensing data; a reporting configuration of the sensing data; a region configuration of the sensing information; or a type parameter of the sensing information.

In an embodiment, the collection configuration of the sensing data includes at least one of: a collection time configuration of the sensing data; or a collection frequency configuration of the sensing data.

In an embodiment, the reporting configuration of the sensing data includes at least one of: a reporting period of the sensing data; a reporting path of the sensing data; a type of the sensing data reported; or a subscription event of reporting of the sensing data.

In an embodiment, the second transceiver module 210 is further configured to: receive parameter update information sent by the SF; and send the parameter update information to the first UE; where the parameter update information is configured for the first UE to update the one or more sensing parameters.

In an embodiment, the sensing information is sent by the first UE; and/or, the sensing information is sent by a second UE, where the second UE is different from the first UE; and/or, the sensing information is sent by a base station.

In an embodiment, the UPF includes at least one of: a session anchor UPF; or an insert UPF.

In an embodiment, the SF includes at least one of: a network data analytics function (NWDAF); a location management function (LMF); or a network exposure function (NEF).

In an exemplary embodiment, the processing module 110, the first transceiver module 120, the second transceiver module 210, and the like may be implemented by one or more central processing units (CPUs), graphics processing units (GPUs), baseband processors (BPs), application specific integrated circuits (ASICs), DSPs, programmable logic devices (PLDs), complex programmable logic devices (CPLDs), field-programmable gate arrays (FPGAs), general purpose processors, controllers, micro controller units (MCUs), microprocessors or other electronic components for performing the aforementioned methods.

FIG. 15 is a block diagram of an apparatus 3000 for transmitting sensing data according to an exemplary embodiment. For example, the apparatus 3000 may be a mobile phone, a computer, a digital broadcasting terminal, a messaging device, a game console, a tablet device, a medical device, a fitness device, a personal digital assistant, or the like.

Referring to FIG. 15, the apparatus 3000 can include one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 generally controls the overall operations of the apparatus 3000, such as operations associated with display, telephone calls, data communications, camera operations, and recording operations. The processing component 3002 can include one or more processors 3020 to execute instructions to complete all or part of the steps of the above methods. In addition, the processing component 3002 can include one or more modules to facilitate interaction between the processing component 3002 and other components. For example, the processing component 3002 can include a multimedia module to facilitate interaction between the multimedia component 3008 and the processing component 3002.

The memory 3004 is configured to store various types of data to support operations at the apparatus 3000. Examples of such data include instructions for any application or method operating on the apparatus 3000, contact data, phone book data, messages, pictures, videos, and so on. The memory 3004 can be implemented by any type of volatile or non-volatile storage device or a combination thereof, such as static random access memory (SRAM), electrically erasable programmable read only memory (EEPROM), erasable programmable read only memory (EPROM), programmable read only memory (PROM), read only memory (ROM), magnetic memory, flash memory, magnetic disk or optical disk.

The power component 3006 provides power to various components of the apparatus 3000. The power component 3006 can include a power management system, one or more power sources, and other components associated with generating, managing, and distributing power for the apparatus 3000.

The multimedia component 3008 includes a screen that provides an output interface between the apparatus 3000 and a user. In some embodiments, the screen can include a liquid crystal display (LCD) and a touch panel (TP). If the screen includes a touch panel, the screen can be implemented as a touch screen to receive input signals from the user. The touch panel includes one or more touch sensors to sense touches, swipes, and gestures on the touch panel. The touch sensor can not only sense boundaries of a touch or swipe action, but also detect the duration and pressure related to the touch or swipe action. In some embodiments, the multimedia component 3008 includes a front camera and/or a rear camera. When the apparatus 3000 is in an operation mode, such as a shooting mode or a video mode, the front camera and/or the rear camera can receive external multimedia data. Each of the front and rear cameras can be a fixed optical lens system or have focal length and optical zooming capabilities.

The audio component 3010 is configured to output and/or input audio signals. For example, the audio component 3010 includes a microphone (MIC) that is configured to receive external audio signals when the apparatus 3000 is in an operation mode, such as a call mode, a recording mode, and a voice recognition mode. The received audio signals can be further stored in the memory 3004 or transmitted via the communication component 3016. In some embodiments, the audio component 3010 further includes a speaker for outputting audio signals.

The I/O interface 3012 provides an interface between the processing component 3002 and peripheral interface modules. The peripheral interface modules can be keyboards, a click wheels, a buttons, or the like. These buttons can include, but are not limited to, home button, volume button, start button, and lock button.

The sensor component 3014 includes one or more sensors for providing the apparatus 3000 with status assessment in various aspects. For example, the sensor component 3014 can detect an open/closed state of the apparatus 3000, relative positioning of components, such as the display and keypad of the apparatus 3000. The sensor component 3014 can also detect a change in position of the apparatus 3000 or a component of the apparatus 3000, the presence or absence of user contact with the apparatus 3000, orientation or acceleration/deceleration of the apparatus 3000, and temperature change of the apparatus 3000. The sensor component 3014 can include a proximity sensor configured to detect the presence of nearby objects without any physical contact. The sensor component 3014 can also include a light sensor, such as a Complementary Metal-Oxide-Semiconductor (CMOS) or Charged Coupled Device (CCD) image sensor, for use in imaging applications. In some embodiments, the sensor component 3014 can further include an acceleration sensor, a gyro sensor, a magnetic sensor, a pressure sensor, or a temperature sensor.

The communication component 3016 is configured to facilitate wired or wireless communication between the apparatus 3000 and other devices. The apparatus 3000 can access a wireless network based on a communication standard, such as Wi-Fi, 2G or 3G, or a combination thereof. In an exemplary embodiment, the communication component 3016 receives broadcast signals or broadcast-related information from an external broadcast management system via a broadcast channel. In one exemplary embodiment, the communication component 3016 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the apparatus 3000 can be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors or other electronic components for performing the above methods.

In an exemplary embodiment, there is also provided a non-transitory computer readable storage medium including instructions, such as the memory 3004 including instructions executable by the processor 3020 of the apparatus 3000 to implement the above methods. For example, the non-transitory computer readable storage medium can be a ROM, a random access memory (RAM), a CD-ROM, a magnetic tape, a floppy disk, and an optical data storage device, etc.

Those skilled in the art will readily recognize other embodiments of the present disclosure upon consideration of the specification and practice of the present disclosure disclosed herein. The present disclosure is intended to cover any variations, uses, or adaptations of the present disclosure, which follow general principles of the embodiments of the present disclosure and include common knowledge or customary means in the art that are not disclosed in the present disclosure. The specification and embodiments are exemplary only, with the true scope and spirit of the present disclosure being indicated by the following claims.

It should be understood that the present disclosure is not limited to the precise structure that has been described above and shown in the drawings, and various modifications and changes may be made without departing from the scope thereof. The scope of the present disclosure is limited only by the appended claims.

1. A method for transmitting sensing data, performed by a first user equipment (UE), the method comprising:
determining sensing data of a sensed object based on received sensing information; and
sending the sensing data to a user plane function (UPF) of a core network through a base station, wherein the sensing data is sent by the UPF to a sensing function (SF) of the core network.

2. The method according to claim 1, wherein determining the sensing data of the sensed object based on the received sensing information comprises at least one of:
taking determined raw sensing data of the sensed object as the sensing data based on the received sensing information and one or more sensing parameters; or
taking a determined sensing result of the sensed object as the sensing data based on the received sensing information and the one or more sensing parameters.

3. The method according to claim 2, wherein the one or more sensing parameters comprise at least one of:
a type parameter of the sensed object;
a collection configuration of the sensing data;
a reporting configuration of the sensing data;
a region configuration of the sensing information; or
a type parameter of the sensing information.

4. The method according to claim 3, wherein the collection configuration of the sensing data comprises at least one of:
a collection time configuration of the sensing data; or
a collection frequency configuration of the sensing data.

5. The method according to claim 3, wherein the reporting configuration of the sensing data comprises at least one of:
a reporting period of the sensing data;
a reporting path of the sensing data;
a type of the sensing data reported; or
a subscription event of reporting of the sensing data.

6. The method according to claim 2, further comprising:
receiving parameter update information sent by the UPF; wherein the parameter update information is sent from the SF to the UPF; and
updating the one or more sensing parameters based on the parameter update information.

7. The method according to claim 1, wherein the sensing information is sent by at least one of:
the first UE;
a second UE different from the first UE; or
a base station.

8. The method according to claim 1, further comprising at least one of:
the UPF comprising at least one of: a session anchor UPF; or an insert UPF; or
the SF comprising at least one of: a network data analytics function (NWDAF); a location management function (LMF); or a network exposure function (NEF).

9. (canceled)

10. The method according to claim 1, wherein determining the sensing data of the sensed object based on the received sensing information comprises:
based on trigger information, determining the sensing data of the sensed object according to the received sensing information;
wherein the triggering information is sent by one of:
an upper layer sensing application function of the first UE;
an upper layer sensing application function of a second UE that sends the sensing information;
a sensing function of one or more base stations of the first UE;
a sensing function of the core network;
a sensing function of a control plane;
a sensing function on the UPF;
an application function of a network to which the first UE belongs; or
application functions outside the network to which the first UE belongs.

11. A method for transmitting sensing data, performed by a user plane function (UPF) of a core network, comprising:
receiving sensing data of a sensed object sent by a first user equipment (UE) through a base station, wherein the sensing data is determined by the first UE based on received sensing information; and
sending the sensing data to a sensing function (SF) of the core network.

12. The method according to claim 11, wherein the sensing data comprises at least one of:
raw sensing data of the sensed object determined by the first UE based on the received sensing information and one or more sensing parameters; or
a sensing result of the sensed object determined by the first UE based on the received sensing information and the one or more sensing parameters.

13. The method according to claim 12, wherein the one or more sensing parameters comprise at least one of:
a type parameter of the sensed object;
a collection configuration of the sensing data;
a reporting configuration of the sensing data;
a region configuration of the sensing information; or
a type parameter of the sensing information.

14. The method according to claim 13, wherein the collection configuration of the sensing data comprises at least one of:
a collection time configuration of the sensing data; or
a collection frequency configuration of the sensing data.

15. The method according to claim 13, wherein the reporting configuration of the sensing data comprises at least one of:
a reporting period of the sensing data;
a reporting path of the sensing data;
a type of the sensing data reported; or
a subscription event of reporting of the sensing data.

16. The method according to claim 12, further comprising:
receiving parameter update information sent by the SF; and
sending the parameter update information to the first UE; wherein the parameter update information is configured for the first UE to update the one or more sensing parameters.

17. The method according to claim 11, wherein the sensing information is sent by at least one of:
the first UE;
a second UE different from the first UE; or
a base station.

18. The method according to claim 11, further comprising at least one of:
the UPF comprising at least one of: a session anchor UPF; or an insert UPF; or
the SF comprising at least one of: a network data analytics function (NWDAF); a location management function (LMF); or a network exposure function (NEF).

19.-21. (canceled)

22. A communication device, comprising:
a processor; and
a memory storing a program executable by the processor,
wherein the processor is configured to:
determine sensing data of a sensed object based on received sensing information; and
send the sensing data to a user plane function (UPF) of a core network through a base station, wherein the sensing data is sent by the UPF to a sensing function (SF) of the core network.

23. A non-transitory storage medium storing an executable program that, when executed by a processor, causes the processor to perform the method according to claim 1.

24. A communication device, comprising:
a processor; and
a memory storing a program executable by the processor,
wherein the processor is configured to perform the method according to claim 11.
